(19) United States
(12) Patent Application Publication
(10) Pub. No.: US 2009/0140734 A1
(43) Pub. Date: Jun. 4, 2009

(54) READOUT ORDERING IN COLLECTION OF RADIAL MAGNETIC RESONANCE IMAGING DATA

(75) Inventor: Wayne R. Dannels, Mentor, OH (US)

Correspondence Address: PHILIPS INTELLECTUAL PROPERTY & STANDARDS, P. O. Box 3001, BRIARCLIFF MANOR, NY, 10510, US

(73) Assignee: Koninklijke Philips Electronics NV, Eindhoven (NL)

(21) Appl. No.: 10/595,753

(22) PCT Filed: Nov. 3, 2004
(86) PCT No.: PCT/IB04/52286

§ 371 Date: May 9, 2006

Related U.S. Application Data
(60) Provisional application No. 60/519,836, filed on Nov. 13, 2003.

(51) Int. Cl. G01V 3/14

(52) U.S. Cl. 324/307

(57) ABSTRACT

In a magnetic resonance imaging apparatus, a sensor (120, 122, 124, 126, 130) measures a displacement of a feature of interest. A magnetic resonance imaging scanner (10) acquires radial readout lines of magnetic resonance imaging data. A reconstruction processor (58) reconstructs the acquired readout lines into reconstructed image data A coordinating processor (134, 140) coordinates a direction of a radial readout line with the determined displacement. The coordinating processor (134, 140) biases at least one of the magnetic resonance imaging scanner (10) and the reconstruction processor (58) toward a selected relationship between readout magnetic field gradient direction and the determined displacement of the feature of interest.

The following relates to the magnetic resonance arts. It finds particular application in magnetic resonance imaging employing radial collection of data, and will be described with particular reference thereto. However, it also finds application in other magnetic resonance applications such as magnetic resonance spectroscopy.

Motion artifacts are a well-known problem both in magnetic resonance imaging and in other imaging modalities. Acquisition of sufficient imaging data for reconstruction of an image takes a finite period of time. Motion of the imaging subject during that finite acquisition time typically results in motion artifacts in the reconstructed image. In the case of medical imaging, motion artifacts can result for example from cardiac cycling, respiratory cycling, and other physiological processes, as well as from patient motion.

In radial magnetic resonance imaging data acquisition, a plurality of readout lines or “projections” are acquired over a span of projection angles. Motion-related image artifacts in images reconstructed from radially acquired magnetic resonance imaging data include a general blurring of the moving object and streaking artifacts that extend from the moving object some distance across the image. The general blurring reduces image resolution of the moving object, while motion-related streak artifacts can produce distinct and sharp artifact features where streaks overlap. In the case of complex motions, streaking artifacts can extend in multiple directions all across the image.

Gated imaging is sometimes used to reduce motion artifacts. In gated imaging, data collection is timed with a gating signal correlated with the motion. For example, in cardiac gated imaging an electrocardiograph or other heart monitor is used to track the cardiac cycle. Imaging data acquisition is temporally restricted to a small portion of the cardiac cycle over which the motion is limited. To acquire a sufficient amount of data for image reconstruction, gated data is acquired over several cardiac cycles. However, motion, including translational motion, of the imaging subject across heartbeats causes misregistry of the data from the successive cardiac cycles. This misregistry corresponds to motion artifacts in the reconstructed image.

The present invention contemplates an improved apparatus and method that overcomes the aforementioned limitations and others.

According to one aspect, a magnetic resonance imaging apparatus is disclosed. A means is provided for acquiring radial readout lines of magnetic resonance imaging data. A means is provided for reconstructing the acquired readout lines into reconstructed image data. A means is provided for coordinating a direction of a radial readout line with a displacement of a feature of interest. The coordinating means biases at least one of the acquiring means and the reconstructing means toward a selected relationship between readout magnetic field gradient direction and the displacement of the feature of interest.

According to another aspect, a magnetic resonance imaging method is provided. A displacement of a feature of interest is determined. A direction of a radial readout line is selected based on the determined displacement. A radial readout line of magnetic resonance imaging data is acquired using a readout magnetic field gradient having the selected direction. The determining, selecting, and acquiring are repeated to collect a dataset of radial readout lines. The dataset of radial readout lines are reconstructed into reconstructed image data.

One advantage resides in reduced motion artifacts in images reconstructed from radially collected magnetic resonance imaging data.

Another advantage resides in reduced streaking artifacts in images reconstructed from radially collected magnetic resonance imaging data.

Yet another advantage resides in reducing motion artifacts by coordinating directions of radial projections with displacement of an imaging feature of interest during data acquisition such that the displacement is generally transverse to the readout magnetic field gradient direction during imaging.

Still yet another advantage resides in reducing motion artifacts by coordinating directions of radial projections with displacement of an imaging feature of interest during data acquisition such that an angle between the displacement and the readout magnetic field gradient direction is generally smoothly varying during imaging.

Numerous additional advantages and benefits will become apparent to those of ordinary skill in the art upon reading the following detailed description of the preferred embodiments.

The invention may take form in various components and arrangements of components, and in various process operations and arrangements of process operations. The drawings are only for the purpose of illustrating preferred embodiments and are not to be construed as limiting the invention.

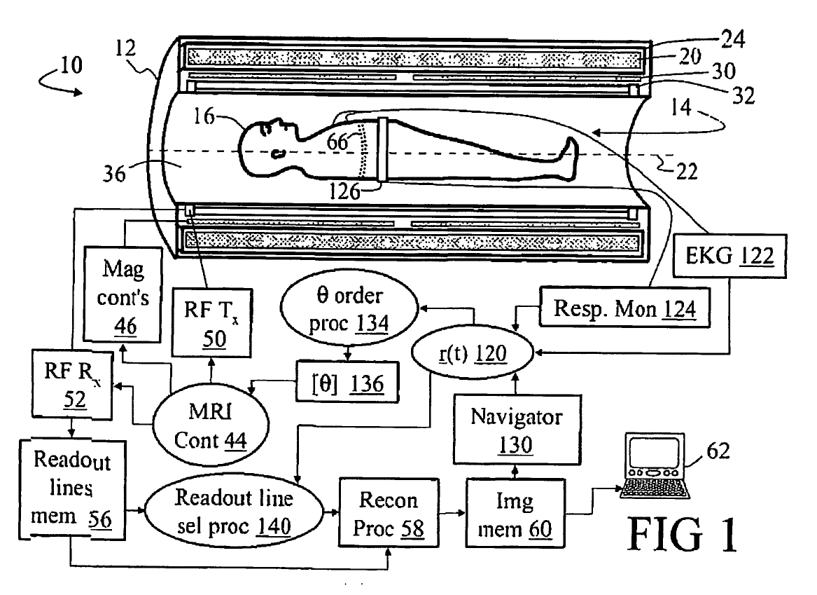

FIG. 1 diagrammatically shows a magnetic resonance imaging system employing a selected readout ordering during radial collection of imaging data. In FIG. 1, the magnetic resonance imaging scanner is illustrated with about one-half of the scanner cut away to reveal internal components of the scanner and to reveal an associated imaging subject disposed in the scanner bore.

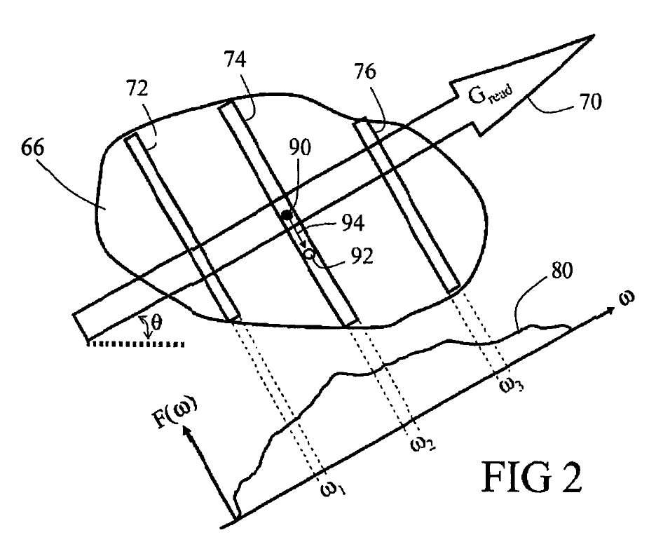

FIG. 2 diagrammatically shows how the angle or direction between readout magnetic field gradient and displacement of a feature of interest affects motion artifacting of a reconstructed image of that feature of interest.

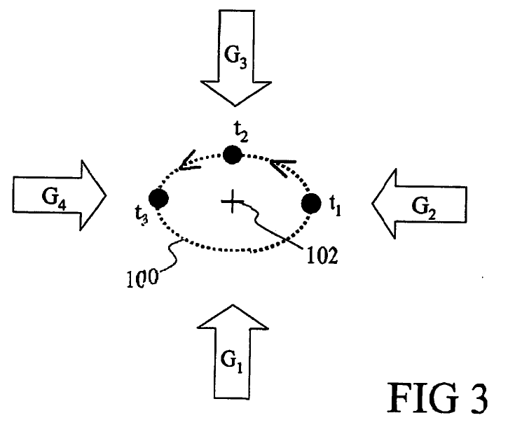

FIG. 3 diagrammatically shows a suitable process for selecting a readout ordering that substantially reduces motion artifacts in the reconstructed image of a feature of interest that follows an oval displacement trajectory.

With reference to FIG. 1, a magnetic resonance imaging scanner 10 includes a housing 12 defining a generally cylindrical scanner bore 14 inside of which an associated imaging subject 16 is disposed. Main magnetic field coils 20 are disposed inside the housing 12. The main magnetic field coils 20 are arranged in a generally solenoidal configuration to produce a main Bo magnetic field directed along a central axis 22 of the scanner bore 14. The main magnetic field coils 20 are typically superconducting coils disposed inside in cryoshrouding 24, although resistive main magnets can also be used. Moreover, the scanner 10 may include additional access openings other than the ends of the cylindrical scanner bore 14 for accessing the imaging subject 16. For example, rather than a closed solenoidal configuration having a closed generally “O”-shaped cross-section, a more open generally “U”-shaped cross-sectional magnet can be employed.

The housing 12 also houses or supports magnetic field gradient coils 30 for selectively producing magnetic field gradients parallel to the central axis 22 of the bore 14, along directions transverse to the central axis 22, or along other selected directions. The housing 12 also houses or supports a birdcage radio frequency body coil 32 for selectively exciting and/or detecting magnetic resonances. Other coils besides a birdcage coil can be used, such as a transverse electromagnetic (TEM) coil, a phased coil array, or other type of radio frequency coil. Moreover, a local coil such as a head coil or a surface coil or coil array can be used. The housing 12 typically includes a cosmetic inner liner 36 defining the scanner bore 14.

The main magnetic field coils 20 produce a main magnetic field B_{O}. A magnetic resonance imaging controller 44 operates magnet controllers 46 to selectively energize the magnetic field gradient coils 30, and operates a radio frequency transmitter 50 coupled to the radio frequency coil 32 to selectively energize the radio frequency coil 32. By selectively operating the magnetic field gradient coils 30 and the radio frequency coil 32, magnetic resonance is generated and spatially encoded in at least a portion of a selected region of interest of the imaging subject 16. The magnetic resonance imaging controller 44 operates a radio frequency receiver 52 coupled to the radio frequency coil 32 along with the gradient coils 30 to read out selected radial magnetic resonance readout lines which are stored in a readout lines memory 56. Rather than using the illustrated coil 32, a local coil, surface coil, phase coils array, or the like can be used for radio frequency transmission or receiving.

A reconstruction processor 58 applies a suitable reconstruction algorithm to reconstruct the readout lines into a reconstructed image including at least a portion of the region of interest of the imaging subject. The reconstructed image is stored in an image memory 60, displayed on a user interface 62, stored in non-volatile memory, transmitted over a local intranet or the Internet, or otherwise viewed, stored, manipulated, or so forth. The user interface 62 can also enable a radiologist, technician, or other operator of the magnetic resonance imaging scanner 10 to communicate with the magnetic resonance imaging controller 44 to select, modify, and execute magnetic resonance imaging sequences.

In a radial scanning mode, magnetic resonance is excited in a volume, slab, or slice of interest defined by magnetic field gradients applied during radio frequency excitation. For example, a slice-selective magnetic field gradient applied along the central axis 22 of the scanner bore 14 enables selective magnetic resonance excitation of an axial slice of the imaging subject 16, such as an example axial slice 66 indicated in FIG. 1. Imaging data of the excited volume, slab, or slice are read out as radial readout lines. Each radial readout line is acquired by applying a readout magnetic field gradient along a selected direction during receiving of the magnetic resonance signal.

With reference to FIG. 2, a diagrammatic example of radial readout of the slice 66 is shown. A direction of a readout magnetic field gradient G_{read} is indicated by the large arrow 70. The readout magnetic field gradient 70 produces a monotonically increasing frequency of the magnetic resonance signal along the gradient 70, while the frequency of the magnetic resonance signal remains constant along a direction transverse to the gradient 70. Thus, for example, a thin portion or column 72 of the slice 66 oriented transverse to the direction of the readout magnetic field gradient 70 emanates magnetic resonance with frequencies lying within a first frequency bin having center frequency ω₁. Another thin portion or column 74 of the slice 66 parallel to the thin portion 72 but disposed further along the gradient 70 emanates magnetic resonance with frequencies lying within a second frequency bin having center frequency ω₂ that is higher than the first center frequency ω₁. Yet another thin portion or column 76 of the slice 66 parallel to the thin portions 72, 74 but disposed still further along the gradient 70 emanates magnetic resonance with frequencies lying within a third frequency bin having center frequency bin ω₃ that is higher than either of the first or second center frequencies ω₁, ω₂.

While three example portions 72, 74, 76 are illustrated, it will be appreciated that a continuum of frequencies are generated along the direction of the readout magnetic field gradient 70. A Fourier transform of the magnetic resonance signal produces a frequency spectrum 80 illustrated in FIG. 2 which corresponds to the radial readout magnetic resonance signal using the readout magnetic field gradient 70 oriented at an angle θ. If a discrete Fourier transform is used, the frequencies are binned into frequency bins such as the illustrated frequency bins having center frequencies ω₁, ω₂, ω₃. In a similar manner, other radial readouts are acquired along other angles.

The radial readout directions may be disposed in a plane, which is conducive to reconstruction of two-dimensional image slices. Optionally, multiple slices can be acquired in this manner to produce a three-dimensional volume image. Alternatively, the radial readout directions may be distributed three-dimensionally along a sphere or hemisphere, which is conductive to reconstruction of three-dimensional volume images.

In the two-dimensional case, typically, a dataset of radial readouts having angles spanning at least about 180° and optionally a larger span such as 360° are acquired and reconstructed by the reconstruction processor 58 into reconstructed image data. In the two-dimensional case, the gradient G_{read} used for acquiring data for the slice 66 is suitably characterized by the angle θ. However, the readout gradient can also be described as a vector in two- or three-dimensions for other radial magnetic resonance imaging data acquisition approaches.

In one suitable reconstruction, the Fourier transform spectra of the radial, readouts are reconstructed using a filtered backprojection reconstruction algorithm. A large number of other reconstruction algorithms are also suitable for reconstructing radial readout magnetic resonance imaging data into reconstructed image data. These reconstructions may operate on the readout signals and/or on the Fourier transform of the readout signals.

With continuing reference to FIG. 2, a feature of interest 90 is illustrated. The feature 90 may, for example, represent a blood vessel of interest, a tumor, a damaged region of the heart or of a lung, or so forth. The feature of interest 90 may move during acquisition of the radial readout lines. For example, if the feature 90 is illustrated in a reference position, the feature may move to a displaced position 92 corresponding to a displacement 94 (indicated by an arrow in FIG. 2) respective to the original reference position. This motion may be due, for example, to the coronary or pulmonary cycle of the patient.

Generally, such motion manifests as motion artifacts in the reconstructed image. However, it will be noted that the displacement 94 lies within the thin portion 74. When the direction of the readout magnetic field gradient 70 is orthogonal to the displacement, the magnetic resonance signal emanating from the feature of interest 90 is unchanged by the displacement 94, Similarly, the Fourier spectrum 80 is unchanged by the displacement 94. In the reference position, the feature 90 emanates magnetic resonance at about the center frequency ω₂. When the feature 90 is displaced to the position 92 corresponding to the displacement 94 which is transverse to the direction of the readout magnetic field gradient 70, the feature 90 also emanates magnetic resonance at about the center frequency ω₂. Indeed, the feature 90 can be displaced anywhere in the thin portion or column 74 without changing its magnetic resonance signal frequency, and without altering the Fourier frequency spectrum 80 or the corresponding time domain magnetic resonance signal. Note that if the readout gradient was instead parallel to the displacement 94, the magnetic resonance signal from the feature 90 would be spread out over a plurality of adjacent thin portions or columns spanned by the displacement 94. As a result, when the radial readout lines are acquired such that during each radial readout line acquisition the direction of the readout magnetic field gradient is generally transverse to the displacement, motion artifacts are substantially reduced.

With reference to FIG. 3, in one example of motion artifact suppression, a feature of interest follows an oval cyclic displacement trajectory 100 (indicated by a dotted trajectory path and directional arrowhead indicators) relative to a reference position 102 (indicated by crosshairs). At a time t₁, either one of positive or negative readout gradients G₁, G₃ having directions transverse to the displacement of the feature at time t₁ is optimally used in acquiring a radial readout line of magnetic resonance data. Similarly, at a time t₂ subsequent to time t₁, either one of positive or negative readout gradients G₂, G₄ having directions transverse to the displacement of the feature at time t₂ is optimally used in acquiring a radial readout line of magnetic resonance data. Typically, an angular span of about 180° or more is acquired. At a time t₃ subsequent to times t₁ and t₂, the gradient G₁ or G₃ not used at time t₁ is optimally used to acquire a radial readout line at time t₃.

In some cases, it may be difficult or impossible to order the readout angles or directions such that each readout is acquired with the displacement transverse to the readout direction. For example, in the case of a linear displacement trajectory, only two readout gradient directions are exactly orthogonal to the linear displacement. However, by biasing the selection of the radial readout angles or directions respective to the displacement trajectory such that readouts at times of maximum displacement of the feature of interest employ readout gradients that are generally transverse to those maximum displacements, motion artifacts can be substantially reduced. Readout gradient directions that cannot be timed to be close to orthogonal to the linear trajectory are acquired at times of minimal displacement of the feature of interest.

Other displacement trajectories besides linear trajectories can produce situations in which the advantageous displacement transverse to readout magnetic field gradient direction condition is difficult or impossible to satisfy for all radial readouts in a set of radial readouts spanning 180° or more. Moreover, the trajectory of a feature of interest may not be known with precision.

In such cases, motion artifacts, and especially streaking motion artifacts, can be reduced by selecting a readout magnetic field gradient angle or direction ordering for the radial readouts in which an angle between the readout magnetic field gradient direction and the displacement of the feature of interest varies smoothly. This smoothly varying ordering recognizes that discontinuities in the variation of the angle between the readout magnetic field gradient direction and the displacement of the feature of interest can lead to substantial streaking image artifacts. A smoother variation suppresses such streaking artifacts.

With reference returning to FIG. 1, a displacement processor 120 determines a displacement r(t) as a function of time. The displacement processor 120 can determine displacement using various types of sensors. For example, a heart monitor such as an electrocardiogram (EKG) 122 measuring the cardiac cycle is suitable for monitoring displacement of vascular features of interest such as the heart and major blood vessels. A respiratory monitor 124 employing a respiratory bellows 126 or other device measuring the respiratory cycle is suitable for monitoring displacement of the lungs, diaphragm, ribs, or other anatomical feature that move in-synch with the respiratory cycle.

EKG and respiratory measurements are typically indirect measurements of motion. The actual motion of the feature of interest is estimated by the displacement processor 120 using a model relating feature motion with the measured cardiac or respiratory cycle. To construct the model, displacement monitoring by an indirect measure such as the EKG 122 or the respiratory monitor 124 can be calibrated using magnetic resonance imaging. The calibration relates displacement in two- or three-dimensions with the measured cardiac, respiratory, or other physiological cycle. Once calibrated, the indirect measurement of the cardiac, respiratory, or other physiological cycle can be employed to provide real-time displacement information.

Rather than employing an indirect measure, motion of the feature of interest can be determined by imaging the feature with the magnetic resonance imaging system. For cyclic motion of the feature of interest, the displacement processor 120 optionally determines the displacement r(t) as a function of time based on magnetic resonance imaging of several motion cycles. A navigator echo means 130 receives rapidly acquired magnetic resonance echoes that are interspersed among the imaging echoes to determine movement and location of the feature of interest.

Advantageously, the method uses relative displacements or trajectories, but can be applied independent of absolute positions. Thus, a motion model determined with a patient at one location in the bore may still be utilized if the patient moves translationally.

In the case of a relatively predictable cyclic displacement trajectory, the displacement calibration can be used to select an ordering of the readout lines that reduces motion artifacts. This can be done either by selecting most readout lines to have readout magnetic field gradient directions transverse to the displacement, or by selecting readout lines to have readout magnetic field gradient directions such, that the angle between the displacement and the gradient direction varies smoothly with gradient direction. Ideally, both are optimized. In this a priori ordering approach, an angular or gradient direction ordering processor 134 optimizes the angles (for two-dimensional imaging, for example the angle θ shown in FIG. 2) or directions (for three-dimensional imaging) of the readout magnetic field gradients based on a suitable figure of merit, to produce a readout gradient angle or readout gradient direction ordering 136 that is implemented during magnetic resonance imaging by the magnetic resonance imaging controller 44. Typically, the imaging will be gated by the cardiac cycle, respiratory cycle, or other reference physiological cycle.

As an example, for the case where the ordering processor 134 selects most readout lines to have readout magnetic field gradient directions transverse to the displacement, a suitable angular or directional ordering optimization method employs a least squares optimization according to:

$$F O M = \sqrt{{\sum }_{N} {( \underline{r} ( t [ n ] ) \cdot \underline{u} ( θ [ n ] ) )}^{2}} , \qquad ( 1 )$$

where n indexes the readout line acquisition order and N is the total number of readout lines (that is, readouts n are acquired in order from n=1 to n=N), t[n] is the time of readout n referenced to a gating signal such as a beginning of the cardiac cycle or respiratory cycle, r(t[n]) is the displacement vector for readout n, u(θ[n]) is a unit vector in the direction of the readout magnetic field gradient used in readout n, the symbol “·” represents a vector dot product (the dot product a·b is identically zero when the vectors a and b are exactly orthogonal), and FOM is a figure of merit that is minimized in the least-squares sense with respect to the ordered set of angles or directions θ[n] to select most readout lines to have readout magnetic field gradient directions transverse to the displacement. The minimized value of the ordered set of angles θ[n] is the angle ordering 136.

Advantageously, the least squares minimization approach biases the readout angle or direction selection toward orienting the readout magnetic field gradient direction generally transverse to the displacement. Moreover, the least squares minimization approach biases more strongly toward a transverse readout gradient for larger displacements. For relatively small magnitudes of displacement r(t[n]), the dot product r(t[n])·u(θ[n]) is relatively small even if the displacement and gradient direction vectors are parallel or anti-parallel. In contrast, for large displacement magnitudes the expression (r(t[n])·u(θ[n]))² increases rapidly as the displacement and gradient direction vectors deviate from being orthogonal and begin to approach a parallel or anti-parallel orientation.

The a priori ordering approach is most effective where the displacement trajectory is cyclic and substantially regular and predictable. For irregular cyclic motion such as in the case of an irregular heartbeat, or for non-cyclic motion, the gradient angle or direction ordering processor 134 can operate substantially concurrently with the magnetic resonance imaging data acquisition to select readout gradient angles or directions for the readout lines on a substantially real-time basis during imaging data acquisition. In this approach, the displacement is determined by the displacement processor 120 just before acquisition of the next readout line. Before the first readout line is acquired, all readout angles or directions are yet to be acquired, and so a readout direction transverse to the measured displacement can be selected. As the number of acquired readout lines increases, the number of readout line angles or directions remaining to be acquired decreases. For later readout lines, the readout line most transverse to the current displacement may be significantly less than perfectly orthogonal. This difficulty can be addressed by acquiring redundant data for some, most, or all gradient angles or directions, thus increasing a likelihood that most gradient angles or directions are acquired with the displacement generally orthogonal thereto.

Alternatively, this difficulty can be addressed by reducing motion artifacts by selecting readout lines to have readout magnetic field gradient directions such that the angle between the displacement and the readout gradient direction varies smoothly with gradient direction. Since the variation of the displacement with time is continuous, the readout magnetic field gradient direction for each readout is readily selected to avoid discontinuities.

Rather than using the displacement trajectory information before or during magnetic resonance data acquisition to order the readout gradient directions before or during data acquisition, the displacement trajectory information can be used after data acquisition to optimally select from amongst a redundant number of readout lines an optimal dataset of readout lines for use in image reconstruction. In this approach, magnetic resonance data is collected while at substantially the same time monitoring the displacement of the feature of interest using the displacement processor 120 and associated sensors such as the EKG 122, the respiratory monitor 124, or the navigator 130. Redundant readout data is collected; that is, more than one readout line is acquired for many, most, or all readout magnetic field gradient angles or directions. For each readout gradient angle or direction θ, there may be for example M acquired readout lines indexed i=1 . . . M. Each acquired readout line has a corresponding displacement vector r[i] identifying the displacement at the time of that readout acquisition. A readout line selection processor 140 selects from amongst the M readout lines that readout line having the smallest dot product r[i]·u(θ), where u(θ) is a unit vector in the direction θ of the readout magnetic field gradient.

The selected readout lines form a dataset which is a sub-set of the acquired readout lines. The selected sub-set of readout lines are reconstructed by the reconstruction processor 58 to produce an image with reduced motion artifacts. Rather than selecting readout lines by minimizing the dot product r[i]·u(θ) so that most readout lines are acquired using readout magnetic field gradients that are substantially transverse to the displacement, the readout line selection processor 140 can select readout lines such that the angle between the displacement and the gradient direction varies smoothly with gradient direction, so as to reduce streaking motion artifacts.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A magnetic resonance imaging apparatus comprising:
a means for acquiring radial readout lines of magnetic resonance imaging data;
a means for reconstructing the acquired readout lines into reconstructed image data; and
a means for coordinating a direction of a radial readout line with a displacement of a feature of interest, the coordinating means biasing at least one of the acquiring means and the reconstructing means toward a selected relationship between readout magnetic field gradient direction and the displacement of the feature of interest.

2. The magnetic resonance imaging apparatus as set forth in claim 1, further including:
a means for determining the displacement of the feature of interest.

3. The magnetic resonance imaging apparatus as set forth in claim 2, wherein the determining means is selected from a group consisting of:
a means for measuring a physiological parameter correlated with displacement of the feature of interest, the displacement being determined based on the measured physiological parameter,
a means for extracting a position of the feature of interest from magnetic resonance imaging data acquired by the acquiring means, the displacement being determined as displacement of the position of the feature of interest from a reference position, and
a magnetic resonance navigator cooperating with the acquiring means.

4. The magnetic resonance imaging apparatus as set forth in claim 1, wherein the coordinating means includes:
a means for biasing the radial readout lines toward orienting the readout magnetic field gradient direction transverse to the displacement.

5. The magnetic resonance imaging apparatus as set forth in claim 4, wherein the coordinating means further includes:
a means for computing an acquisition order of radial readout lines, the acquisition order being biased by the biasing means toward orienting the readout magnetic field gradient direction transverse to the displacement, the acquiring means acquiring the readout lines of magnetic resonance imaging data in the acquisition order.

6. The magnetic resonance imaging apparatus as set forth in claim 4, wherein the coordinating means operates substantially concurrently with the acquiring means, the coordinating means selecting a readout magnetic field gradient direction of a next readout line acquisition based on a present displacement of the feature of interest.

7. The magnetic resonance imaging apparatus as set forth in claim 4, wherein the coordinating means further includes:
a means for selecting a dataset of acquired readout lines that is a sub-set of the acquired readout lines, the selecting being biased by the biasing means toward selecting readout lines for which the readout magnetic field gradient direction is generally transverse to the displacement, the reconstructing means reconstructing the dataset of acquired readout lines into reconstructed image data.

8. The magnetic resonance imaging apparatus as set forth in claim 1, wherein the coordinating means includes:
a means for selecting an ordering of radial readout lines for which an angle between the readout magnetic field gradient direction and the displacement varies smoothly.

9. The magnetic resonance imaging apparatus as set forth in claim 8, wherein the coordinating means further includes at least one of:
a means for controlling the acquiring means to acquire readout lines of magnetic resonance imaging data having the selected ordering, and
a means for selecting a dataset of acquired readout lines that is a sub-set of the acquired readout lines, the dataset having the selected ordering, the reconstructing means reconstructing the dataset of acquired readout lines into reconstructed image data.

10. The magnetic resonance imaging apparatus as set forth in claim 1, wherein the coordinating means includes:
a means for determining an optimized ordering of a set of readout lines based on a cyclic displacement trajectory, the acquiring means acquiring the radial readout lines of magnetic resonance imaging data using the optimized ordering.

11. The magnetic resonance imaging apparatus as set forth in claim 10, wherein the means for determining an optimized ordering includes:
an optimizing means for optimizing the ordering of the set of readout lines to minimize a figure of merit indicative of the selected relationship between readout magnetic field gradient direction and the determined displacement of the feature of interest.

12. A magnetic resonance imaging method comprising:
determining a displacement of a feature of interest;
selecting a direction of a radial readout line based on the determined displacement;
acquiring a radial readout line of magnetic resonance imaging data using a readout magnetic field gradient having the selected direction;
repeating the determining, selecting, and acquiring to collect a dataset of radial readout lines; and
reconstructing the dataset of radial readout lines into reconstructed image data.

13. The magnetic resonance imaging method as set forth in claim 12, wherein the selecting of a direction includes at least one of:
biasing the direction toward orienting the radial readout line direction generally transverse to the displacement,
biasing more strongly for large displacements, and
selecting the direction such that an angle between the direction and the displacement of the feature of interest varies smoothly.

14. The magnetic resonance imaging method as set forth in claim 12, wherein the determining of a displacement of a feature of interest is repeated to determine a cyclic displacement of the feature of interest, and the selecting of a direction of a radial readout line based on the determined displacement includes:
optimizing an ordering of a set of readout lines with respect to the cyclic displacement of the feature of interest, the acquiring of a radial readout line of magnetic resonance imaging data including acquiring a plurality of readout lines in the selected ordering.

15. The magnetic resonance imaging method as set forth in claim 14, wherein the optimizing of the ordering is such that when the displacement of the feature of interest is large the acquired radial readout line has a direction selected substantially orthogonal to the large displacement.

16. The magnetic resonance imaging method as set forth in claim 12, wherein the determining of a displacement of a feature of interest is repeated to determine a cyclic displacement of the feature of interest, and the selecting of a direction of a radial readout line based on the determined displacement includes:
selecting a sub-set of the acquired radial readout lines based on an angle between the readout line and the displacement of the feature of interest at the time the readout line was acquired, the reconstructing being performed on the selected sub-set.

17. The magnetic resonance imaging method as set forth in claim 16, wherein the selecting of a sub-set uses a criterion selected from a group consisting of:
selecting a sub-set biased toward a 90° angle between readout magnetic field gradient direction and displacement of the feature of interest, and
selecting a sub-set in which the angle between the readout line and the displacement of the feature of interest varies smoothly.

18. The magnetic resonance imaging method as set forth in claim 12, wherein the determining of a displacement of a feature of interest includes one of:
measuring a physiological parameter correlated with displacement of the feature of interest, the displacement being determined based on the measured physiological parameter,
extracting a position of the feature of interest from acquired magnetic resonance images, the displacement being determined as displacement of the position of the feature of interest from a reference position, and
acquiring magnetic resonance echoes interspersed among the imaging echoes to determine the displacement of the feature of interest.

19. A magnetic resonance imaging apparatus comprising:
a main magnet;
magnetic field gradient coils;
a radio frequency coil;
a processor for performing the method of claim 12; and
a reconstruction processor.

20. A magnetic resonance imaging apparatus comprising:
a sensor measuring a displacement of a feature of interest;
a magnetic resonance imaging scanner acquiring radial readout lines of magnetic resonance imaging data;
a reconstruction processor reconstructing the acquired readout lines into reconstructed image data; and
a coordinating processor coordinating a direction of a radial readout line with the determined displacement, the coordinating processor biasing at least one of the magnetic resonance imaging scanner and the reconstruction processor toward a selected relationship between readout magnetic field gradient direction and the determined displacement of the feature of interest.
